(19) United States
(12) Patent Application Publication
(10) Pub. No.: US 2024/0049738 A1
(43) Pub. Date: Feb. 15, 2024

(54) COMPOSITION COMPRISING RAPESEED PROTEIN

(71) Applicant: DSM IP Assets B.V., HEERLEN (NL)

(72) Inventors: Johanna Corline Margriet VINK, Echt (NL); Mirna BOSNJAK, Echt (NL); Arjen SEIN, Echt (NL)

(21) Appl. No.: 18/257,007

(22) PCT Filed: Dec. 17, 2021
(86) PCT No.: PCT/EP2021/086486

§ 371 Date: Jun. 12, 2023

(30) Foreign Application Priority Data
Dec. 18, 2020 (EP) 20215537.0

(51) Int. Cl. A23C 20/02

(52) U.S. Cl. CPC A23C 20/025

(57) ABSTRACT

The invention relates to a composition comprising rapeseed protein, a vegetable oil, starch and water wherein the composition has a pH from 3-5.5, and to a method for the preparation of a fresh cheese analogue.

### FIELD OF THE INVENTION

The present invention is directed to a composition comprising rapeseed protein, starch, vegetable oil and water, and to the use of such composition in cheese analogues. Further, the present invention relates to a method for the preparation of a fresh cheese analogue.

### BACKGROUND OF THE INVENTION

Food products comprising plant proteins as alternative to animal-derived proteins nowadays receive attention because of consumer concerns about the environmental impact of animal-based products and the beneficial nutritional characteristics of plant-based foods. In particular, the use of plant proteins in dairy-alternative products such as milk, yoghurt, or cheese, cream cheese or fresh cheese have gained popularity.

Plant proteins may be derived from a variety of legumes and pulses such as soybean, pea, chickpea, fava bean, lentil, mung bean, peanut, lupin; oil seeds/cabbages such as rapeseed or canola, sunflower, camelina, sesame; cereals and pseudo cereals, such as wheat, barley, oat, rice, sorghum, quinoa, buckwheat; nuts, such as almond, hazelnut, walnut, cashew; coconut; nightshades such as potato.

Unfortunately, addition of plant proteins into food products with a high water activity/content, such as cream cheese or fresh cheese, can lead to physio-chemical instability issues such as protein aggregation, phase separation, or precipitation of food particles. This occurs particularly upon heat treatment such as is necessary in order to pasteurize the product for shelf life and to ensure optimum starch gelatinization.

The instant invention is concerned with food products such as a cream cheese comprising a particular plant protein, rapeseed protein. Unfortunately, this protein usually is no exception to the problem outlined above, i.e. uncontrolled aggregation can occur under certain circumstances used during the production of cream cheese. Cream cheese is a mild, acid-coagulated uncured cheese. Traditional methods of manufacturing cream cheese start with a cream and milk mixture that is pasteurized and homogenized. Subsequently, the mix is cooled down and an acidifying agent is added to decrease the pH to around 4-5, causing texture development by controlled aggregation of the protein and fat particles. The acidifying agent may be either a food grade acidulent or lactic acid producing culture. Methods for preparing a non-dairy cream cheese often start with a protein powder mixture that is blended into an oil-in-water emulsion. The mixture is heated to pasteurize and/or thicken the complex carbohydrates such as starch or hydrocolloids. Subsequently, acidification takes place using food grade acidulants. A problem associated with the use of vegetable proteins such as rapeseed protein in cream cheeses equivalents is that uncontrolled aggregation occurs after treatment at elevated temperatures under neutral pH conditions. Uncontrolled aggregation as a consequence of heating is unwanted as it may lead to inhomogeneous products, lump or grit formation and phase separation of for instance the fat or the serum phase. There is therefore a need for a production process and food composition comprising rapeseed protein that does not lead to the problem mentioned above.

U.S. Pat. No. 4,324,804 relates to a method for the manufacture of dairy-based cream cheese with a soft spreadable texture and body at refrigeration temperature and to the soft-bodied cream cheese product thereby provided, that is acidified by cheese cultures to a pH of less than 5.2.

WO2019133679 relates to non-dairy semi-soft cheese analogues prepared by blending water, pea protein, coconut oil, potato starch and sunflower oil, adding high acyl gellan gum and sugar without any pH adjustment, and allowed to set for two days.

WO2018/115597 relates to plant-based cheese like products such as cottage cheese, produced by providing a granule and an emulsion, and combining them in the desired ratio, using the enzyme transglutaminase to obtain the particular, granular character. Cottage cheese type of products display this crumbly, granular texture that does not spread smoothly like cream cheese or cheese spreads do, but rather in crumbly lumps.

### DETAILED DESCRIPTION OF THE INVENTION

In the context of the present invention, the term “smoothness” refers to a consistent texture free of grit or lumps.

The term “spreadability” or “spreadable” as used herein refers to a cohesive texture that requires easy deformation, such as peanut butter (without intact pieces of peanut), margarine or spreads, and spreading, generally by a knife onto a food (bread) without rupturing the food, leading to a smooth layer without irregularities like lumps or grits, or voids/pockets with air or aqueous phase/serum. The spreading action should lead to substantial pressure on the object by which spreading is obtained (e.g. a knife). Thus a smooth product like mayonnaise spreads smoothly but is too soft, and cold butter directly from the fridge is too hard to spread smoothly.

The term “firmness” as used herein refers to the force required to compress the cream cheese. Firmness and hardness can be used interchangeably.

Spreadability or spread firmness can be measured by standard techniques such as a texture analyser, for instance by a TA.XTplus instrument, from Stable microsystems Ltd, Surrey, UK, using a standard protocol designed by the instrument manufacturer to characterize spreadability and firmness in one measurement, see for instance https://www.stablemicrosystems.com/MeasureSpreadability.html. The method uses a 45° cone-shaped cylindrical Perspex probe to penetrate the surface of the cream cheese analogue or spread until a depth of 10 mm is reached, retracts and performs another penetration. The force-time curve can be recorded with software and the firmness (N) of the cream cheese analogue is extracted from the (maximum) positive peak force of the first deformation. The spreadability of the product is given by the work represented by the area of the first deformation, expressed in Force×Time (N·s) or Force×distance (N·m).

The term “elasticity” as used herein refers to the degree the product returns to its original size/shape after partial compression, such as can be experienced between the tongue and palate or teeth.

The term “creamy” as used herein refers to a smooth, mouth-coating, full mouthfeel with a dairy-fat-like taste.

By the expression “a starch” is to be understood a type of starch. By the expression “a vegetable oil” is to be understood a type of vegetable oil or fat. By the expression “an acid” is to be understood a type of acid. By the expression “a hydrocolloid” is to be understood a type of hydrocolloid.

The term ‘cheese analogue’ or ‘cheese alternative’ as used herein refers to a cheese type product that is derived from non-animal sources.

A cream cheese is a spreadable cheese or alternatively can be a cheese spread. Margarines and other butter-like spreads are usually fat continuous. In the context of this patent a spread is a water-continuous product, preferably an oil-in-water emulsion.

In the context of the present invention the term “DIAAS” refers to Digestible Indispensable Amino Acid Score and is calculated as recommended by the Food and Agriculture Organization of the United Nations (Report of an Expert Consultation (2013) is of the Food and Agriculture Organization of the United Nations (FAO); Dietary Protein Quality Evaluation in Human Nutrition) using equation DIAAS (%)=100× lowest value of the DIAA reference ratio. The DIAAS values may be calculated for different age groups and in the context of the present invention this is done according to the above FAO recommendation for 3 different age groups. These are infants (from birth to 6 mo.), children (from 6 mo. to 3 yr.), and older children, adolescents and adults (>3 yr.).

The term “DIAA reference ratio” refers to Digestible Indispensable Amino Acid reference ratio and is calculated according to Cervantes-Pahm et al. (Br. J. Nutr. (2014) 111:1663-1672) using equation DIAA reference ratio=digestible indispensable amino acid content in 1 g protein of food (mg)/mg of the same dietary indispensable amino acid in 1 g of the reference protein.

As used herein, all the percentages are by weight (wt %) of the total weight of the cream cheese unless expressed otherwise.

In a first aspect a composition is provided comprising rapeseed protein (isolate), a vegetable oil, starch and/or water, wherein the composition has a pH from 3-5.5. It was found that instability associated with the production of cream cheese comprising rapeseed protein can be overcome by providing a composition according to the present invention.

The rapeseed used to obtain the rapeseed protein (isolate) as applied in the instant invention is usually of the varieties Brassica napus or Brassica juncea. These varieties contain low levels of erucic acid and glucosinolates, and are the source of canola, a generic term for rapeseed oil comprising less than 2% erucic acid and less than 30 mmol/g glucosinolates. The predominant storage proteins found in rapeseed are cruciferins and napins. Cruciferins are globulins and are the major storage protein in the seed. A cruciferin is composed of 6 subunits and has a total molecular weight of approximately 300 kDa. Napins are albumins and are low molecular weight storage proteins with a molecular weight of approximately 14 kDa. Napins are more easily solubilized and are primarily proposed for use in applications where solubility is key. Rapeseed proteins can also be divided into various fractions according to the corresponding sedimentation coefficient in Svedberg units (S). This coefficient indicates the speed of sedimentation of a macromolecule in a centrifugal field. For rapeseed proteins, the main reported fractions are 12S, 7S and 2S. Napin is a 2S albumin, and cruciferin is a 12S globulin. In the context of the present invention, the rapeseed protein isolate comprises from 15 to 65% (w/w) cruciferins and from 35 to 85% (w/w) napins, the total being equal to or less than 100%, and has a solubility of at least 88% when measured over a pH range from 3 to 10 at a temperature of 23±2° C. In the context of the present invention, the rapeseed protein comprises cruciferins and napins, preferably from 15 to 65% (w/w) cruciferins and from to 85% (w/w) napins, the total being equal to or less than 100%.

In one embodiment the rapeseed protein comprises 40-65% (w/w) cruciferins and 35-60% (w/w) napins, or comprises 80-100% (w/w) cruciferins and 0-20% (w/w) napins, or comprises 0-20% (w/w) cruciferins and 80-100% (w/w) napins, wherein the sum of cruciferins and napins is not exceeding 100% (w/w).

In a preferred embodiment, the present rapeseed protein (isolate) comprises 40 to 65 wt. % cruciferins and 35 to 60 wt. % napins (of the rapeseed protein). Preferably, the present rapeseed protein comprises 40 to 55 wt. % cruciferins and 45 to 60 wt. % napins.

In a preferred embodiment, the present rapeseed protein (isolate) comprises 60 to 80 wt. % cruciferins and 20 to 40 wt. % napins. Preferably, the present rapeseed protein comprises 65 to 75 wt. % cruciferins and 25 to 35 wt. % napins.

In a preferred embodiment, the present rapeseed protein (isolate) comprises 0 to 10 wt. % cruciferins and 90 to 100 wt. % napins. Preferably, the present rapeseed protein comprises 1 to 5 wt. % cruciferins and 95 to 100 wt. % napins.

Preferably, the amounts of cruciferins and napins calculated based on the total amount of protein in the present cake mix. Or alternatively, the amounts of cruciferins and napins are calculated based on the sum of cruciferins and napins present in the cake mix. Preferably, the amounts of cruciderins and napins are determined by size exclusion chromatography (SEC). Preferably, the amounts of cruciderins and napins are determined by size exclusion chromatography (SEC) using the following test:

samples of protein isolate are dissolved in a 500 mM NaCl saline solution and analyzed by High Performance SEC using the same solution as the mobile phase, followed by detection using measuring UV absorbance at 280 nm, wherein the relative contribution of cruciferin and napin (wt. %) was calculated as the ratio of the peak area of each protein with respect to the sum of both peak areas.

Preferably, the present rapeseed protein (isolate) comprises 40 to 65 wt. % 12S and to 60 wt. % 2S. Preferably, the present rapeseed protein comprises 40 to 55 wt. % 12S and 45 to 60 wt. % 2S.

In a preferred embodiment, the present rapeseed protein (isolate) comprises 60 to 80 wt. % 12S and 20 to 40 wt. % 2S. Preferably, the present rapeseed protein comprises 65 to 75 wt. % 12S and 25 to 35 wt. % 2S.

In a preferred embodiment, the present rapeseed protein (isolate) comprises 0 to 10 wt. % 12S and 90 to 100 wt. % 2S. Preferably, the present rapeseed protein comprises 1 to 5 wt. % 12S and 95 to 100 wt. % 2S.

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test:

samples of protein isolate are dissolved in a 3.0% (or 500 mM) NaCl saline solution and amounts determined using interference optics.

While 12 S and 2S, or cruciferin and napin, make up the vast majority of the proteins found in rapeseed protein, other proteins can be present in small amounts (less than 5% w/w, 2% w/w/, less than 1% w/w), such as oleosin.

In a preferred embodiment, the composition comprises a ratio of cruciferin to napin in the range of from 1 cruciferin to 0.5 napin to 1 cruciferin to 1.5 napin. Alternatively, the present composition comprises a ratio of cruciferin to napin of at least 9 cruciferin to 1 napin or comprising a ratio of cruciferin to napin of 1 cruciferin to at least 9 napin.

In an embodiment, the amount of rapeseed protein is from 0.5-10% (w/w) of the composition, preferably from 1-6% (w/w) of the composition, preferably from 2-5% (w/w) of the composition, preferably from 0.5-4% (w/w) of the composition, preferably from 1-3.5% (w/w) of the composition, preferably from 1.6-5% (w/w) of the composition, preferably from 1.6-3% (w/w) of the composition.

In an embodiment, the composition does not comprise gluten or gliadin, i.e. the composition is so called gluten free. By gluten free is meant that the composition comprises less than 20 ppm of gluten and more preferably less than 10 ppm of gluten. Gluten is usually measured by measuring the gliadin content, for example as described in WO 2017/102535. Therefore, according to the present invention there is provided a gluten free composition comprising less than 10 ppm gliadin.

In another embodiment the composition does not comprise soy-derived protein. In still another embodiment the composition does not comprise gluten or gliadin and does not comprise soy-derived protein.

Alternatively, a mixture of rapeseed protein and other proteins can be used, such as other plant based proteins such as proteins from legumes and pulses such as pea protein, soy protein, fava bean protein, chickpea protein, lupin protein, lentil protein, mung bean protein, peanut; or seed proteins such as cotton seed protein, sunflower seed protein, sesame seed protein, camelina; cereal or pseudo cereal protein, such as oat protein, rice protein, corn protein, sorghum protein, quinoa protein, buckwheat; leaf protein such as alfalfa protein, clover protein, duckweed protein, grass protein; protein from stem or root tuber protein such as potato protein, sweet potato protein, cassava protein, yam protein, taro protein; protein derived from nuts, such as almond, hazelnut, walnut, cashew; coconut protein, or proteins from algal, insect or microbial sources, or animal-derived proteins such as milk protein or egg protein.

In an embodiment, the amount of rapeseed protein+other plant based protein is from 0.5-10% (w/w) of the composition, preferably from 1-6% (w/w) of the composition, preferably from 2-5% (w/w) of the composition, preferably from 0.5-4% (w/w) of the composition, preferably from 1-3.5% (w/w) of the composition, preferably from 1.6-5% (w/w) of the composition, preferably from 1.6-3% (w/w) of the composition.

In an embodiment, the present composition has a pH 3-5.5, or 3.5-5.5, such as a pH of 3.0, 3.1, 3.2, 3.3, 3.4, 3.4, 3.5, 3.6, 3.7, 3.8, 3.9 4.0, 4.1, 4.2, 4.3, 4.4, 4.5, 4.6, 4.7, 4.8, 4.9, 5.0, 5.1, 5.2, 5.3, 5.4 or 5.5.

In an embodiment, the present composition comprises lactic acid, citric acid, malic acid, or glucono delta-lactone, or phosphoric acid, or combinations thereof. Preferably the acid is present in an amount of 0.1-10% (w/w), or 0.5-5% (w/w) or 1-3% (w/w).

In a preferred embodiment, the amount of rapeseed protein is from 0.1-10% (w/w), the amount of vegetable oil is from 1-60% (w/w) and/or the amount of starch is from 1-15% (w/w).

Preferably, wherein the amount of rapeseed protein is from 0.1-10% (w/w), wherein the amount of vegetable oil is from 10-40% (w/w) and/or wherein the amount of starch is from 1-15% (w/w).

In another embodiment, the total amount of starch (single ingredient or mixture of more than one) is from 1.0-20% (w/w), or from 5.0-10% (w/w). Starch for use in the present invention can be native, non-modified or modified starch (degraded, enzymatically modified, chemically modified, or stabilized), or mixtures thereof.

In an embodiment, the amount of vegetable oil is from 5-50% (w/w), from 10 to 40% (w/w), from 15 to 35% (w/w) or from 20 to 30% (w/w) of the composition.

In an embodiment, the vegetable oil is liquid at 5° C., or the vegetable oil is solid at 5° C., or combinations thereof. Hence, the vegetable oil can be a combination of oil that is liquid at 5° C. with an vegetable oil that is solid at 5° C.

In an embodiment, the vegetable oil comprises a vegetable oil having a solid fat content of 40-90% (w/w), preferably 45-80% (w/w), or 50-70% (w/w) at 5° C.

Preferably, the present vegetable oil comprises more than 90% (w/w) triglycerides.

In the context of the invention, suitable vegetable oils are corn oil, olive oil, rapeseed oil or canola oil, soya bean oil, sunflower oil, camelina oil, groundnut oil, cotton is seed oil, safflower oil, sesame oil, rice bran oil; all oils that are essentially liquid at room temperature. Further in the contest of this invention, the vegetable oil may also contain oils that are solid or partially solid at room temperature, such as coconut oil, palm kernel oil, babassu oil, palm oil, shea butter, cocoa butter. Alternatively, fractions of the vegetable oils may be used, or mixtures of the vegetable oils mentioned before, either a mixture as such, or after chemical of enzymatic interesterification. Optionally, a part of the vegetable oil is a blend that is obtained by oil or fat that may be hardened by suitable methods known in the art. A preferred vegetable oil comprises coconut oil and sunflower oil.

In an embodiment, the balance (to 100% w/w) of the remaining ingredients in the present composition may be water, preferably the balance is water. More preferably, the present composition comprises an amount of water up to 100% (w/w) of the composition. Preferably, the present composition comprises an amount of water of 40-95% (w/w) of the composition, more preferably of 50-75% (w/w) of the composition.

In an embodiment, the present composition further comprises an emulsifier and/or a hydrocolloid, preferably wherein the amount of emulsifier is from 0.02-2% (w/w), preferably wherein the amount of hydrocolloid is from 0.02-1% (w/w).

In an embodiment, the composition further may comprise an emulsifier. An emulsifier promotes formation and/or stability of emulsions. Suitable emulsifiers may be the ones known to the skilled person, for example phospholipids (e.g. lecithin and the like), fractionated, or hydrolyzed, or calcium, magnesium, potassium, or sodium salts of fatty acids, mono- and diglycerides (MDG), preferably saturated MDG, and derivatives thereof such as lactic acid esters (“Lactem”) of MDG, acylated tartaric acid esters (“Datem”) of MDG, sorbitan esters of monostearate (Tweens and Spans), sugar esters of fatty acids, polyglycerolesters of fatty acids and the like. Typically, combinations of emulsifiers can be used, such as a combination of MDG and lactic acid esters of MDG. Typically, between 0.1 and 1.5% emulsifier is used. Preferably, the amount of emulsifier is from 0.02-2% (w/w) of the composition, preferably the amount of emulsifier is from 0.1-1.5% (w/w) of is the composition such as around 0.3-0.5% (w/w) of the composition.

In an embodiment the present composition may comprise a hydrocolloid. Hydrocolloids are a diverse group of long chain polymers characterized by their property of forming viscous dispersions and/or gels when dispersed in water. In the context of the invention, suitable hydrocolloids are galactomannans (guar gum, locust bean gum (LBG) and tara gum), gellan (including low or high-acyl gellan), xanthan, low- and high-methoxy pectins, alginates, carrageenans, gum Arabic, cellulose derivatives such as carboxymethyl cellulose, hydroxypropylmethyl cellulose, methyl cellulose, native and modified starches, citrus fibers and the like. Preferably, the amount of hydrocolloid is from 0.02-1% (w/w) of the composition. More preferably, the amount of hydrocolloid is from 0.1-1% (w/w) of the composition. More preferably, the present composition comprises gellan gum and pectin, more preferably high acyl gellan gum and low methoxy pectin.

In an embodiment, the present composition may comprise minerals, such as sodium chloride, potassium chloride or calcium phosphate. Calcium salts, such as for example calcium phosphate or calcium lactate, have the advantage that the nutritional value of dairy products can be mimicked. Certain counterions may impact the protein behaviour in the composition. Preferably, the amount of minerals is within the range of 0.05-1% (w/w) of the composition, such as from 0.1-0.5% (w/w) of the composition.

In an embodiment, the composition is an oil-in-water emulsion. Preferably an oil-in-water emulsion wherein the size of the emulsion droplets has a D50 within the range of 1-50 μm and/or a D90 within the range of 5-70 μm or a D50 within the range of 2-30 μm and/or a D90 within the range of 5-50 μm, preferably a D50 within the range of 5-15 μm and/or a D90 within the range of 10-30 μm. Preferably, the size of the emulsion droplets has a D50 within the range of 2-20 μm, 3-15 μm, 4-12 μm, 5-10 μm. Preferably, the size of the emulsion droplets has a D90 within the range of 10-20 μm, 5-15 μm, 10-25 μm, 5-10 μm. The droplet size—expressed as the D50, D10 or D90, can be measured by particle size distribution assessment methods such as light scattering, and further checked using light microscopy.

Preferably, the size of the emulsion droplets is determined using light scattering, preferably by laser diffraction particle size analysis, such as with a Beckman-Coulter LS13320 particle size analyzer, combined with the Fraunhofer.rf780d model. Typical settings are a pump speed set at 40%, laser obscuration around 20% (780 nm) and the PIDS obscuration around 40% (450 nm). The 10%, 50% (median) and 90% particle size for a volume distribution were annotated as D10, D50 and D90 (=X10, X50, X90). Any person skilled in the art will be able to analyze the PSD on light scattering instruments such as used here.

For determining the PSD in a cream cheese analogue, samples were diluted in ratio 1:1 (weight basis) with demineralized water and finely dispersed by using a Vortex shaker.

Light microscopy analysis was employed to confirm the droplet sizes being essentially smaller than indicated values. For this an Olympus CX41 microscope equipped with UC30 digital microscope camera and U-TV1X-2 adapter (Olympus) was used. Samples were prepared undiluted, directly after processing. Magnification was set at 20 times.

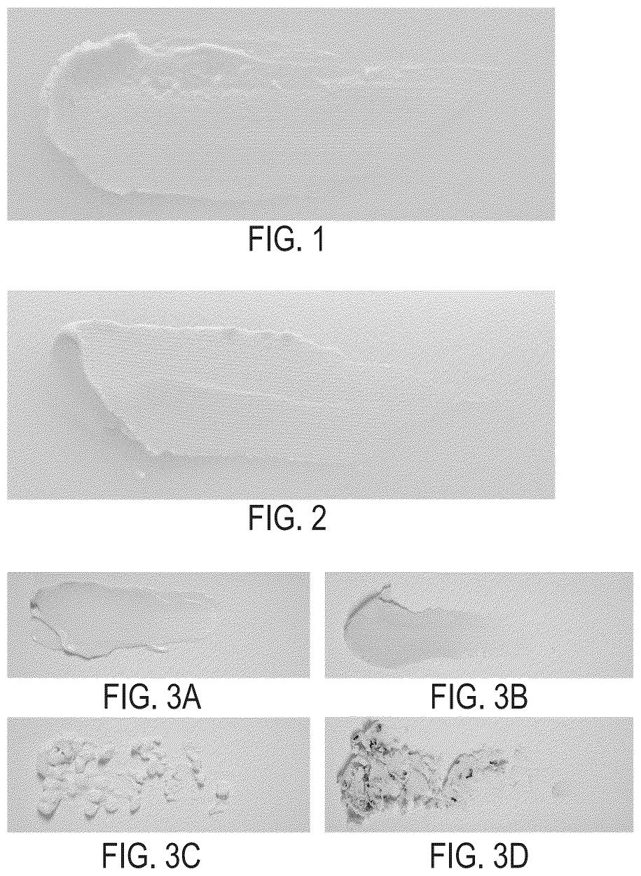

In a preferred embodiment, the present composition further comprises pea protein, wherein the ratio of pea protein:rapeseed protein is 90:10 to 5:95. Preferably, the ratio of pea protein:rapeseed protein is from 80:20 to 10:90, 75:25 to 25:75, 60:40 to 40:60 or is from 80:20 to 50:50 or 50:50 to 20:80. The present inventors found that addition of rapeseed protein to pea protein improves the spreadability of the cream cheese analogue. A 100% pea protein based cream cheese as a poor spreadability, as is shown in FIG. 1.

In an embodiment, the present composition further comprises a plant-based material, or a plant-based milk. Examples are so-called plant-based milks which can be made from a plant source by dispersing seeds, grains or nuts into an aqueous phase, optionally removing part of the fibers and cell debris by filtration or centrifugation. Preferably, the plant-based material or plant-based milk is selected from a variety of legumes and pulses such as soybean, pea, chickpea, fava bean, lentil, mung bean, peanut, lupin; oil seeds/cabbages such as rapeseed or canola, camelina, sesame, sunflower; cereals and pseudo cereals, such as wheat, barley, oat, rice, sorghum, quinoa, buckwheat; nuts, such as almond, hazelnut, walnut, cashew; coconut; nightshades such as potato.

In an embodiment, the present composition is a fresh cheese analogue, preferably a fresh cheese analogue chosen from the group of cream cheese, feta, mozzarella, crème fraiche, fromage blanc, ricotta, mascarpone, cheese spread and quarg (or quark). In other words, the present composition is preferable a non-dairy fresh cheese, like a non-dairy cream cheese.

In an embodiment, the composition is a cream cheese analogue which has a spreadable consistency at a temperature of 2-10° C. In other words, the present cream cheese is readily spreadable while having a temperature of 2-10° C.

In an embodiment, the present composition has a firmness measured according to test A within the range of 30 to 500 N, preferably 35 to 400 N, preferably 40 to 300 N, preferably 50 to 200 N, preferably 60 to 150 N.

In an embodiment, the present composition has a spreadability (or spread firmness) measured according to test A within the range of 200 to 2000 N.s, preferably within the range of 220 to 1500 N.s, preferably within the range of 250 to 1000 N.s, preferably 300 to 800 N.s.

Test A comprises:
storing the present composition for 24 hours at 4° C.; and (without allowing the present composition to acclimatize to room temperature)
measuring with a texture analyser (preferably TA, TA.XTplus, Stable microsystems Ltd, Surrey, UK), with a 45° cone-shaped cylindrical (preferably Perspex) probe to penetrate the surface of the present composition until a depth of 10 mm, using a Pre-test speed set at 5 mm/s, test speed set at 1 mm/s and using two subsequent penetrations with 5 seconds in between;
recording the force-time curve (preferably with Exponent software);
calculating the firmness (N) by the (maximum) positive peak force of the first deformation; and/or -calculating the spreadability (N.s) by the work represented by the area of the first deformation curve.

In an embodiment, the present rapeseed protein has an enthalpy of denaturation in the hydrated state (ΔH value) of around 0, for example of from 0 to 1 J/g or of 0±0.5 J/g. The ΔH value may be established for example by measuring a 40% (w/w) solution or dispersion of rapeseed protein isolate in water by means of Differential Scanning calorimetry (DSC). This enthalpy of denaturation can be the result of the pasteurization step. Native rapeseed protein isolate usually has an enthalpy of denaturation in the hydrated state of from 1 to 10 J/g, or of from 2 to 6 J/g of a 40% (w/w) protein solution.

In an embodiment the rapeseed protein isolate has a DIAAS value in older children, adolescents and adults aged 3 yr. and older which is equal to or higher than 100. In an embodiment the DIAAS value is from 100 to 200, or from 105 to 150, or from 110 to 135. For example, the DIAAS value may be 110±10.

In an embodiment, the present rapeseed protein isolate has a DIAAS value, preferably a DIAAS value in older children, adolescents and adults aged 3 yr. and older, which is equal to or higher than 100. In an embodiment the DIAAS value is from 100 to 200, or from 105 to 150, or from 110 to 135. For example, the DIAAS value may be 110±10. Preferably, the DIAAS value is from 101 to 130, or from 102 to 125, or from 103 to 120, or from 103 to 115.

It was found that heat-treated rapeseed protein has superior DIAAS values compared to other plant-derived proteins. As is shown in the experimental part, pasteurization temperatures might denature the protein and increase the DIAAS value. This is advantageous for the fresh cheeses according to the present invention, as they have a beneficial nutritional value.

Therefore, in a preferred embodiment, the present invention relates to a cream cheese comprising rapeseed protein, a vegetable oil, starch and water, wherein the rapeseed protein has a DIAAS value of which is equal to or higher than 100. In an embodiment the DIAAS value is from 100 to 200, or from 105 to 150, or from 110 to 135. For example, the DIAAS value may be 110±10. Preferably, the DIAAS value is from 101 to 130, or from 102 to 125, or from 103 to 120, or from 103 to 115.

In a second aspect, the invention provides a method for the preparation of a fresh cheese analogue, or a cream cheese analogue as defined herein, comprising the steps of:
a) preparing an emulsion comprising rapeseed protein, a vegetable oil, starch and water;
b) homogenizing the emulsion, preferably using high shear; and
c) pasteurizing the composition.

Preferably, the present method further comprises after step c):
d) homogenizing the pasteurized emulsion using a high-pressure homogenizer, preferably using a rotor/stator mixer.

The present inventors found that instability associated with the production of fresh cheese, particularly cream cheese or cheese spread, comprising rapeseed protein can be overcome sufficient shear (such as high-pressure homogenization), before the heating step. The instant invention demonstrates that by making an acidic oil-in-water emulsion, rapeseed protein is more resistant to aggregation upon heating.

In an embodiment, the emulsion obtained in step a) has a pH from 2-6.5, preferably a pH from 3-5.5, more preferable a pH from 3.5-5.5. The present inventors found that by acidification of the present composition, or emulsion, a stable fresh cheese, particularly cream cheese or cheese spread, can be obtained.

In an embodiment, the emulsion obtained in step a) has a droplet size D50 of less than 50 μm. Preferably the emulsion obtained in step a) has an emulsion droplets size D50 within the range of 1-50 μm and/or a D90 within the range of 5-70 μm or a D50 within the range of 2-30 μm and/or a D90 within the range of 5-50 μm, preferably a D50 within the range of 5-15 μm and/or a D90 within the range of 10-30 μm. Preferably, the size of the emulsion droplets has a D50 within the range of 2-20 μm, 3-15 μm, 4-12 μm, 5-10 μm. Preferably, the size of the emulsion droplets has a D90 within the range of 10-20 μm, 5-15 μm, 10-25 μm, 5-10 μm.

In an embodiment, step a) comprises the use of a hydrocolloid and/or an emulsifier. Preferably an hydrocolloid and/or emulsifier as defined above in the first aspect of the invention.

In an embodiment, the present method further comprises a step d) or e) of adding lactic acid bacteria to the homogenized and/or pasteurized composition and allowing the lactic acid bacteria to adjust the pH to a value of pH 3-5. The advantage of adding lactic acid bacteria is that a fermented product is obtained. Alternatively, an acid can be added to the homogenized and/or pasteurized composition. The degree of acidification after pasteurization is dependent on the degree of acidification of the composition, or emulsion, before pasteurization. For example, if the emulsion obtained in step a) has a pH of 5, further acidification after pasteurization might be used in order to provide a fresh cheese product.

In present step a) an emulsion is prepared. The skilled person is aware of common techniques for the preparation of an emulsion. For example, present step a) comprises mixing the rapeseed protein, starch with water, and stirring the mixture was stirred for >10 minutes to fully hydrate the protein to create an aqueous solution, and melting the vegetable fat, optionally adding a liquid oil to the melted fat, followed by dispersing the melted fat or the vegetable oil or the mixture of melted fat and oil into the aqueous solution using a high-shear mixer.

High-shear mixers, such as rotor/stator mixers, are commonly used in the production of emulsions. The term ‘high shear’ is defined as shear sufficient to result in an oil-in-water emulsion, wherein the size of the emulsion droplets has a D50 within the range of 1-50 μm and/or a D90 within the range of 10-70 μm. Alternatively phrased, present step a) comprises preparing an emulsion with the rapeseed protein, the vegetable fat, the starch and the water using shear, resulting in an oil-in-water emulsion, wherein the size of the emulsion droplets has a D50 within the range of 2-30 μm and/or a D90 within the range of 10-50 μm.

The pasteurization of step c) may be carried out with a cooking mixer, such as a Thermomixer, Kenwood induction machine, Stephan machine, or alternative comparable equipment, and similar processes on industrial scale. To ensure optimum starch gelatinization, the product should be treated at a temperature of 70° C. to 120° C. for 1 minutes to 15 minutes, such as 80° C. to 110° C. for 1 minutes to 15 minutes. On industrial scale this may be carried out with direct or indirect tubular heat exchange systems, or other processes known in the art. This pasteurization might result in a rapeseed protein isolate having an enthalpy of denaturation in the hydrated state (AH value) of around 0, for example of from 0 to 1 J/g or of 0±0.5 J/g, as defined above.

In an embodiment, a calcium salt may be added during any one of steps a), b), c) or d) of the method of the second aspect. Calcium ions may mimic the nutritional value of dairy products like cream cheese and/or may control moisture content and/or acidity. Possible sources of calcium ions are tricalcium phosphate or calcium lactate. The calcium source may preferably be added in step a) or after the heat treatment in step c).

In an embodiment, a plant-based milk or plant-based material may be added, preferably as a full or partial replacement of the water, in the emulsion that is prepared during step a). Suitable plant-based milks and materials are defined above in the first aspect of the invention.

In a third aspect, the invention provides use of the present composition in cheese analogues, preferably a fresh cheese analogue chosen from the group of cream cheese, feta, mozzarella, crème fraiche, fromage blanc, ricotta, mascarpone, cheese spread and quarg. Preparation of a plant-based equivalent of cream cheese comprises a heating step in order to pasteurize the product for shelf life and to ensure optimum starch gelatinization, i.e. treatment at a temperature of 70° C. to 120° C. for 10 seconds to 15 minutes.

### EXAMPLES

### Materials and Methods

Rapeseed protein isolate was prepared from cold-pressed rapeseed oil seed meal as described in WO 2018/007492; the protein content was 90% (w/w). The resultant rapeseed protein isolate comprised in the range of from 40 to 65% (w/w) cruciferins and 35 to 60% (w/w) napins, contained less than 0.26% (w/w) phytate and had a solubility of at least 88% when measured over a pH range from 3 to 10 at a temperature of 23±2° C.

Palm kernel oil was from AAK, coconut oil was from Bio+ (The Netherlands), sunflower oil from Albert Heijn (The Netherlands). Tapioca starch (Claria bliss 570) was from Tate and Lyle. Sucrose (witte basterdsuiker) was from Van Gilse (The Netherlands). Low methoxy (LM-)pectin was from Modernist Pantry and DSM (APC300FB) and high acyl (HA-)gellan was from DSM (ND102). Unless stated otherwise, all other chemicals were from Sigma-Aldrich. Pea protein DMPP80plus was obtained from JianYuan, China.

High shear mixer was from Silverson, Thermomixer from Vorwerk (Switzerland), Cooking chef induction machine (KM080AT) from Kenwood (Japan), Homogenizer (M110D) from Microfluidics.

### Measurement of pH

The pH was measured using a Radiometer (PHM220) combined with a Hamilton Slimtrode electrode (SN21564).

### Measurement of Moisture Content

Moisture content was measured using the CEM SMART 6 moisture/solids analyzer, according the following applied settings: power 100%, max run time 10 minutes, max temperature 135° C., min sample weight 1.90 g, max sample weight 2.10 g.

### Measurement of Denaturation Behaviour

Differential Scanning calorimetry (DSC) was carried out by preparing 40% solutions/dispersions of protein isolate in water. Approximately 30 mg of the solution/dispersion was pipetted into an aluminum container of 40 μL after which thermograms were acquired with the following settings:
DSC: Mettler Toledo DSC 1
Temp. profile: Step 1: 10 minutes isothermally at 25° C.;
   Step 2: 5° C.-125° C.
Rate: Rate 1: not applicable; Rate 2: 5° C./min
Reference: Empty 40 μL aluminum container with sealed lid
Sample: 20-30 mg in 40 μL aluminum container with sealed lid
Atmosphere: N₂ at 50 mL/min

Values for ΔH were determined by integration of the endothermal peak with STAR^{e} software (version 12.10b) from Mettler Toledo. Enthalpies (ΔH) were normalized to J/g of a 40% protein solution.

### Method Texture Analysis—Firmness, Spreadability—

With a texture analyzer (TA, TA.XTplus, Stable microsystems Ltd, Surrey, UK), the firmness and spreadability of the cream cheese alternatives were determined. This was done with a 45° cone-shaped cylindrical Perspex probe to penetrate the surface of the cream cheese until a depth of 10 mm. Pre-test speed was set at 5 mm/s, test speed was set at 1 mm/s, two subsequent penetrations were performed, similar to a standard Texture Profile Analysis. The force-time curve was recorded with Exponent software. The cream cheese alternatives were analyzed in triplicate, after 1 day of storage at 4° C. The firmness (N) of the cream cheese alternative is given by the (maximum) positive peak force of the first deformation. The spreadability (N.s) of the cream cheese alternative is given by the work represented by the area of the first deformation curve.

### Particle Size Distribution

PSD light scattering: Laser diffraction particle size analyses were performed with the Beckman-Coulter LS13320 particle size analyzer, combined with the Fraunhofer.rf780d model. The pump speed was set at 40%. The laser obscuration was around 20% (780 nm) and the PIDS obscuration around 40% (450 nm). The 10%, 50% (median) and 90% particle size for a volume distribution were annotated as D10, D50 and D90 (=X10, X50, X90).

For determining the PSD, samples were diluted in ratio 1:1 (weight basis) with demineralized water and finely dispersed by using a Vortex shaker.

Light microscopy analysis was performed with the Olympus CX41 microscope equipped with UC30 digital microscope camera and U-TV1X-2 adapter (Olympus). Samples were prepared undiluted, directly after processing Magnification was set at 20 times.

### Color Measurement

Color Measurement was performed using an internally developed method, by which surface colour was characterized by a colour scanner (Epson Perfection V600 Photo scanner) and translated to LAB and RGB values. Color is defined as a fixed point in three-dimensional space. The parameters measured are the L, a, and b values.
L value: the amount of white saturation in a sample: a value of 100 is white, a value of 0 is black
a value: the color saturation green to red: a positive value is the red saturation, a negative value is the green saturation
b value: the color saturation yellow to blue: a positive value is the yellow saturation, a negative value is the blue saturation

### Example 1

### Exploration of Starch, Fat and Protein Content in Rapeseed Protein Cream Cheese Analogues

Cream cheeses comprising rapeseed protein isolate were prepared as follows. A blend with dry ingredients was prepared, containing rapeseed protein isolate, tapioca starch, sucrose, calcium phosphate and sodium chloride. Water and acid were added to the dry blend in a 1 L-beaker. The solution was mixed with a magnetic stirring bar for at least 30 minutes at room temperature. The coconut oil was melted using a water bath at 40° C., mixed with the sunflower oil and the mix was added to the hydrated protein solution. This was emulsified by vigorously mixing at maximum speed for 1 minute using a high is shear mixer (Silverson). The emulsion was homogenized at 500 bar using a homogenizer from Microfluidics and subsequently heated for 15 minutes at 95° C. in a cooking chef induction machine equipped with stirring tool (Kenwood). Samples were prepared in batches of 400 g and varied in pH values ranging from 6.5-4.5 before heating (Table 1, sample 1-5). It was observed that the compositions with a pH≤6 were stable upon heating, while the compositions with higher pH values showed substantial aggregation and product inhomogeneity.

TABLE 1
Effect of pH on rapeseed protein cream cheeses analogues

| Ingredient | Sample | Sample | Sample | Sample | Sample |
|---|---|---|---|---|---|
| % w/w | 1 | 2 | 3 | 4 | 5 |
| Coconut oil | 12 | 12 | 12 | 12 | 12 |
| Sunflower oil | 11 | 11 | 11 | 11 | 11 |
| Tapioca starch | 5.5 | 5.5 | 5.5 | 5.5 | 5.5 |
| Rapeseed protein | 3.5 | 3.5 | 3.5 | 3.5 | 3.5 |
| isolate | | | | | |
| Sucrose | 1.5 | 1.5 | 1.5 | 1.5 | 1.5 |
| Calcium phosphate | 0.33 | 0.33 | 0.33 | 0.33 | 0.33 |
| Sodium chloride | 0.80 | 0.80 | 0.80 | 0.80 | 0.80 |
| 0.2-0.3M lactic | 0.0 | 0.3 | 0.5 | 0.8 | 1.0 |
| acid + 0.1M | | | | | |
| citric acid | | | | | |
| Water | 65 | 64 | 64 | 64 | 64 |
| Total weight | 100 | 100 | 100 | 100 | 100 |
| pH | 6.50 | 6.00 | 5.50 | 5.00 | 4.50 |
| Product stability | Unstable | Stable | Stable | Stable | Stable |
| after heat | | | | | |

### Example 2

### Exploration of Starch, Fat and Protein Content in Rapeseed Protein Cream Cheese Analogues

Cream cheeses comprising rapeseed protein isolate were prepared as described in Example 1. Variation in starch, fat and protein content were made (Table 2, Sample 6-10). The products were evaluated on their spreadability and taste after overnight storage at 4° C. The composition with 12% coconut oil, 11% sunflower oil, 5.5% tapioca starch and 3.5% rapeseed protein isolate (sample 10), showed high creaminess and improved spreadability.

TABLE 2
Compositions of rapeseed protein cream cheeses analogues

| Ingredient | Sample | Sample | Sample | Sample | Sample |
|---|---|---|---|---|---|
| % w/w | 6 | 7 | 8 | 9 | 10 |
| Coconut oil | 10 | 12 | 12 | 12 | 12 |
| Sunflower oil | 10 | 11 | 11 | 11 | 11 |
| Tapioca starch | 7.0 | 7.0 | 7.0 | 6.0 | 5.5 |
| Rapeseed protein | 2.5 | 2.5 | 3.5 | 3.5 | 3.5 |
| isolate | | | | | |
| Sucrose | 1.5 | 1.5 | 1.5 | 1.5 | 1.5 |
| Calcium phosphate | 0.33 | 0.33 | 0.33 | 0.33 | 0.33 |
| Sodium chloride | 0.80 | 0.80 | 0.80 | 0.80 | 0.80 |
| 0.2-0.3M lactic | 1.2 | 1.2 | 1.2 | 1.2 | 1.2 |
| acid + 0.1M | | | | | |
| citric acid | | | | | |
| Water | 66 | 64 | 64 | 64 | 64 |
| Total weight | 99 | 100 | 101 | 100 | 99 |
| pH | 4.38 | 4.46 | 4.03 | 4.11 | 4.10 |
| Observation | Firm and | Improved | No effect of | Improved | Improved |
| | coarse | creamy taste | increased | spread- | spread- |
| | texture | and smoother | protein | ability | ability |
| | | texture | content | | |

### Example 3

Rapeseed Protein Cream Cheese Analogue with Oat Milk

Cream cheeses comprising rapeseed protein isolate were prepared as described in Example 1. Instead of water oat milk was used that was prepared as follows. Oat flour (200 g) was dispersed in tap water (1800 g) using a Thermomixer at speed 5 (Vorwerk). The oat dispersion was heated to 60° C. and the mixing speed was decreased to 1.5. DelvoPlant ALT (120 μL, 1000 ppm) and DelvoPlant GLU (144 μL, 1200 ppm) enzymes (DSM) were added to the oat dispersion and incubated for 2 hours at 60° C. and speed 1.5. To inactivate the enzymes, the mixture was heated to 95° C. for 15 minutes. The oat milk was cooled down to room temperature and sieved with a 100 μm sieve before addition to the dry cream cheese ingredients. The oat milk contained 3.14% glucose, 0.49% maltose and 0.01% maltotriose (w/w). No additional sucrose was added to the cream cheese. Cream cheeses with different concentrations tapioca starch were prepared (Table 3, Sample 11-13). In general, the cream cheeses comprising oat milk showed a less elastic texture that improved the spreadability, compared to the sample 6-10 (Table 2). A starch content of around 5.5-5.0% was found to be optimal.

TABLE 3
Compositions of rapeseed protein cream
cheeses analogue with oat milk

| Ingredient | Sample | Sample | Sample |
|---|---|---|---|
| % w/w | 11 | 12 | 13 |
| Coconut oil | 12 | 12 | 12 |
| Sunflower oil | 11 | 11 | 11 |
| Tapioca starch | 6.0 | 5.5 | 5.0 |
| Rapeseed protein | 3.5 | 3.5 | 3.5 |
| isolate | | | |
| Sucrose | 0 | 0 | 0 |
| Calcium phosphate | 0.33 | 0.33 | 0.33 |
| Sodium chloride | 0.80 | 0.80 | 0.80 |
| 0.2-0.3M lactic | 1.2 | 1.2 | 1.2 |
| acid + 0.1M | | | |
| citric acid | | | |
| Water | 66 | 66 | 66 |
| Total weight | 101 | 100 | 100 |
| pH | 3.93 | 3.93 | 3.92 |
| Observation | Oat milk | Good | Good |
| | improved the | texture | texture |
| | spreadability: | and | and |
| | less elastic | | |
| | gel, still | spread- | spread- |
| | bit too firm | ability | ability |

### Example 4

Rapeseed Protein Cream Cheese Analogue with Additional Stabilizers

Cream cheese comprising rapeseed protein with LM-pectin and HA-gellan was prepared as described in Example 1. The dry ingredient blend was hydrated with 50% of the water. Separately, a hydrocolloid dispersion was made with LM-pectin and HA-gellan and the remaining 50% of the water. Both dispersions were mixed with a magnetic stirring bar for at least 30 minutes at room temperature. The hydrocolloid dispersion was heated up to 87° C. and cooled down to 40° C. using a water bath. The protein and hydrocolloid dispersions were mixed. Subsequently, the melted coconut oil and sunflower oil were combined and added, and the mixture was emulsified, homogenized and heated as described in Example 1. The cream cheese analogue comprising LM-pectin and HA-gellan showed less syneresis during 1 week of storage at 4° C.

TABLE 4
Composition of rapeseed protein cream cheese
analogue with LM-pectin and HA-gellan

| Ingredient % w/w | Sample 14 |
|---|---|
| Coconut oil | 12 |
| Sunflower oil | 11 |
| Tapioca starch | 7.5 |
| Rapeseed protein isolate | 2.5 |
| Sucrose | 1.5 |
| Calcium phosphate | 0.33 |
| Sodium chloride | 0.80 |
| 0.2-0.3M lactic acid + | 1.2 |
| 0.1M citric acid | |
| LM-pectin | 0.6 |
| HA-gellan | 0.04 |
| Water | 64 |
| Total weight | 99 |
| pH | 4.77 |
| Observation | Improved stability |
| | during storage |

### Example 5

### Preparation of Heat-Treated RPI

Native RPI (60 kg; obtained according to WO 2018/007492) was dissolved in osmosed water (540 kg) at 55° C. with high-speed turbine mixer preventing foam formation. The temperature was increased to 90° C. and maintained at 90° C. for 10 minutes during which process aggregation was observed. The temperature was lowered to 70° C. and the mixture was ground with a high-speed turbine mixer for 15 minutes and further sheared using an Ultra-Turrax (at 18,000 rpm/370 kg/h). The resulting suspension was dried in a spray drying tower, with inlet/outlet air temperature set at 195/90° C. respectively, and a dryer feed rate of approximately 100 kg/h. This resulted in 24 kg of heat-treated RPI powder.

The material had a Total Microbial Plate Count (by standard method NF EN ISO 4833-1, measured at 30° C.) of <100 CFU/g, and for yeasts (by standard method NF V 08-036, measured at 25° C.) of <10 CFU/g.

Protein content of the dry powder was measured using standard Dumas measurement and denaturation behavior was measured using DSC. These measurements were also carried out for the starting non-heated RPI and for WPI, SPI, PPC and BPC (Table 5).

The heat-treated product had a solubility of 47%, whereas the starting native RPI had a solubility of 89%. The heat-treated product had a water content of 8.1% (average of two measurements).

TABLE 5
Protein content and denaturation behavior
of protein isolates/concentrates

| | | | ΔH 40% |
|---|---|---|---|
| | N | N × 6.25 | solution |
| | (mg/kg) | (g/kg) | (J/g) |
| Rapeseed protein isolate (RPI) | 157000 | 981 | 5.7 |
| Whey protein isolate (WPI) | 141000 | 881 | 2.5 |
| Pea protein concentrate (PPC) | 127000 | 794 | 0 |
| Brown rice protein concentrate (BPC) | 129000 | 806 | 0 |
| Soy protein isolate (SPI) | 138000 | 863 | 0 |
| RPI, heat-treated | 157000 | 981 | 0 |

### Example 6

### Determination of Digestible Indispensable Amino Acid Score of Various Proteins

The Digestible Indispensable Amino Acid Score (DIAAS) of six proteins was determined. These proteins (Table 6) included WPI, SPI, PPC, BPC, RPI (WO 2018/007492), and RPI heat-treated prepared as outlined in Example 5.

TABLE 6
Analyzed amino acid composition of proteins

| Item (%) | RPI | RPI heat-treated | WPI | SPI | BPC | PPC |
|---|---|---|---|---|---|---|
| Dry matter | 95.34 | 97.92 | 95.59 | 96.35 | 97.24 | 93.55 |
| Crude protein | 98.83 | 99.72 | 88.04 | 87.63 | 80.99 | 55.33 |

Indispensable amino acids

| | | | | | | |
|---|---|---|---|---|---|---|
| Arg | 6.30 | 6.33 | 1.72 | 6.50 | 6.11 | 6.73 |
| His | 3.08 | 3.12 | 1.63 | 2.25 | 1.76 | 1.97 |
| Ile | 3.79 | 3.80 | 6.83 | 4.34 | 3.60 | 4.04 |
| Leu | 6.81 | 6.89 | 9.36 | 6.78 | 6.53 | 6.50 |
| Lys | 5.91 | 5.99 | 8.81 | 5.46 | 2.19 | 6.03 |
| Met | 1.95 | 1.95 | 1.93 | 1.10 | 2.06 | 0.79 |
| Phe | 3.77 | 3.81 | 2.89 | 4.63 | 4.44 | 4.54 |
| Thr | 3.26 | 3.31 | 6.97 | 3.12 | 2.63 | 2.75 |
| Trp | 1.41 | 1.52 | 2.07 | 1.20 | 1.01 | 0.73 |
| Val | 4.94 | 4.99 | 5.90 | 4.49 | 5.08 | 4.32 |
| Total | 41.22 | 41.71 | 48.11 | 39.87 | 35.41 | 38.4 |

Dispensable amino acids

| | | | | | | |
|---|---|---|---|---|---|---|
| Ala | 4.06 | 4.11 | 4.64 | 3.70 | 4.39 | 3.38 |
| Asp | 5.51 | 5.51 | 10.56 | 9.54 | 6.71 | 8.94 |
| Cys | 3.43 | 3.33 | 2.39 | 1.01 | 1.76 | 0.80 |
| Glu | 22.09 | 22.25 | 16.78 | 15.97 | 13.61 | 12.88 |
| Gly | 4.65 | 4.65 | 1.56 | 3.66 | 3.40 | 3.24 |
| Pro | 7.18 | 6.97 | 6.04 | 4.51 | 3.64 | 3.53 |
| Ser | 2.91 | 2.92 | 3.78 | 3.54 | 3.05 | 3.30 |
| Tyr | 2.01 | 2.01 | 2.68 | 3.29 | 4.11 | 3.02 |
| Total | 51.84 | 51.75 | 48.43 | 45.22 | 40.67 | 39.09 |
| Total amino acids | 93.06 | 93.46 | 96.54 | 85.09 | 76.08 | 77.49 |

The DIAAS value was calculated for age group above 3 years old using the following equation [1] (FAO, 2013):
[1] DIAAS (%)=100×lowest value of the DIAA reference ratio

TABLE 7
Digestible indispensable amino acid score (DIAAS) in older children, adolescents and adults (≥3 yr.)

| | | | | | | | | |
|---|---|---|---|---|---|---|---|---|
| | | RPI heat- | | | | | Pooled | |
| Item | RPI | treated | WPI | SPI | BPC | PPC | SEM | P-value |

DIAA reference ratio

| | | | | | | | | |
|---|---|---|---|---|---|---|---|---|
| His | 1.57 | 1.90 | 1.17 | 1.56 | 1.09 | 1.45 | | |
| Ile | 0.91 | 1.21 | 2.55 | 1.55 | 1.16 | 1.55 | | |
| Leu | 0.83 | 1.10 | 1.74 | 1.18 | 1.03 | 1.24 | | |
| Lys | 1.02 | 1.19 | 2.07 | 1.26 | 0.42 | 1.51 | | |
| SAA² | 1.96 | 2.20 | 2.11 | 0.97 | 1.43 | 0.70 | | |
| AAA³ | 0.99 | 1.38 | 1.55 | 2.10 | 1.98 | 2.15 | | |
| Thr | 0.95 | 1.25 | 2.92 | 1.29 | 1.01 | 1.23 | | |
| Trp | 1.65 | 2.27 | 3.58 | 2.03 | 1.71 | 1.27 | | |
| Val | 0.90 | 1.19 | 1.62 | 1.19 | 1.23 | 1.21 | | |
| DIAAS, % | 83 | 110 | 117 | 97 | 42 | 70 | 1.38 | <0.001 |
| Older child, | (Leu) | (Leu) | (His) | (SAA) | (Lys) | (SAA) | | |
| adolescent, | | | | | | | | |
| adult⁴ | | | | | | | | |

¹First-limiting amino acid is in parentheses.
²SAA = Sulfur Amino Acids.
³AAA = Aromatic Amino Acids.
⁴DIAAS calculated using the recommended scoring pattern for an older child/adolescent/adult (≥3 yr.).
The indispensable AA reference patterns are expressed as mg AA/g protein: His, 16; Ile, 30; Leu, 61; Lys, 48; SAA, 23; AAA, 41; Thr, 25; Trp, 6.6; Val, 40).

### Example 7

Cream Cheese with Pea and Rapeseed Protein

Plant-based cream cheese alternatives comprising rapeseed protein and pea protein were prepared as described in Example 1. A dry ingredient blend was prepared, containing rapeseed protein isolate (RPI), pea protein isolate (PPI), potato starch, sucrose, calcium phosphate, sodium chloride and LM-pectin. Water and acid were added to the dry blend in a 1 L-beaker. The dispersions were mixed with a magnetic stirring bar for at least 30 minutes at room temperature, and pH was measured and found to be below 5.5. The melted coconut oil and sunflower oil were combined and added, and the mixture was emulsified by vigorously mixing at maximum speed for 1 minute using a high-shear mixer (Silverson). The emulsion was heated for 5 minutes at 95° C., using a tubular UHT-line at a flow of 10 L/h (OMVE). The emulsion was cooled down to 20° C. and inline, downstream homogenized at 230 bar (high-pressure homogenizer, Gea). Samples were prepared in batches of 3500 g.

The samples varied in level of total protein powder and starch, and ratio rapeseed protein isolate to pea protein isolate (Table 8-3.5% protein, and Table 9-6 or 10% protein, sample 15-24). The spreadability and mouthfeel improved substantially with the partial replacement of pea protein isolate by rapeseed protein isolate. A more balanced taste profile was obtained for the cream cheeses containing both rapeseed and pea protein. An increase in total protein levels to 6.0% and 10%, only limitedly impacted the appearance, spreadability, mouthfeel and taste. All cream cheese alternatives were relatively white and showed good shelf-stability during 3-week storage at 4° C. The median particle size and firmness of the products were observed in the range as expected for cream cheese alternatives. Samples 16, 18 and 19, all having equal amounts of starch, indicate that increasing the amount or rapeseed protein decreases the particle size.

TABLE 8
Compositions of rapeseed protein cream cheese analogues in combination with different
ratios pea protein isolate. Total level of protein powder was set at 3.5% w/w.

| Sample nr | 15 | 16 | 17 | 18 | 19 |
|---|---|---|---|---|---|
| Ingredient % w/w | RPI-PPI | RPI-PPI | RPI-PPI | RPI-PPI | RPI-PPI |
| | 0:1 | 1:4 | 1:3 | 1:1 | 1:0 |
| Total level of | 3.5% | 3.5% | 3.5% | 3.5% | 3.5% |
| protein powder | | | | | |
| w/w | | | | | |
| Coconut oil | 12 | 12 | 12 | 12 | 12 |
| Sunflower oil | 11 | 11 | 11 | 11 | 11 |
| Potato starch | 3.0 | 3.5 | 2.8 | 3.5 | 3.5 |
| (Avebe, Etenia | | | | | |
| 457) | | | | | |
| Potato starch | 2.6 | 3.0 | 2.4 | 3.0 | 3.0 |
| (Avebe, Etenia | | | | | |
| 505) | | | | | |
| Rapeseed protein | 0 | 0.7 | 0.88 | 1.75 | 3.5 |
| isolate | | | | | |
| Pea protein | 3.5 | 2.8 | 2.68 | 1.75 | 0 |
| isolate | | | | | |
| DMPP80Plus | | | | | |
| Sucrose | 1.5 | 1.5 | 1.5 | 1.5 | 1.5 |
| Calcium | 0.33 | 0.33 | 0.33 | 0.33 | 0.33 |
| phosphate | | | | | |
| NaCl | 0.8 | 0.8 | 0.8 | 0.8 | 0.8 |
| LM-pectin | 0.5 | 0.5 | 0.5 | 0.5 | 0.5 |
| (DSM, APC300FB) | | | | | |
| 0.2M Lactic | 0.8 | 0.8 | 0.8 | 0.8 | 0.8 |
| acid/0.1M | | | | | |
| citric acid | | | | | |
| Water | 63 | 63 | 63 | 63 | 63 |
| Total weight | 99 | 100 | 97 | 100 | 100 |
| (g) | | | | | |
| pH | 4.33 | 4.37 | 4.33 | 4.36 | 4.29 |
| L* | 98.36 | 96.76 | 96.82 | 95.40 | 92.78 |
| a* | −1.00 | −1.47 | −1.55 | −1.80 | −2.38 |
| b* | 6.55 | 7.84 | 8.57 | 9.28 | 10.69 |
| Median particle | 19 | 23 | 30 | 18 | 16 |
| size (μm) | | | | | |
| Texture analysis: | 85 | 102 | 70 | 87 | 97 |
| Firmness (N) | | | | | |
| Texture analysis: | 400 | 478 | 335 | 418 | 460 |
| spreadability | | | | | |
| (N · s) | | | | | |
| Appearance | White, | White, | Light | Light | Light |
| | matte, | shiny, | beige/ | beige/ | beige/ |
| | without | without | yellowish, | yellowish, | yellowish, |
| | syneresis | syneresis | shiny, | shiny, | shiny, |
| | | | without | without | without |
| | | | syneresis | syneresis | syneresis |
| Spreadability | Weak | Good | Good | Good | Good |
| | coarse | spread- | spread- | spread- | spread- |
| | and | ability | ability | ability | ability |
| | crumbly | | | | |
| | consistency | | | | |
| Mouthfeel | Very dry, | Smooth | Smooth | Smooth | Smooth |
| | chalky and | and | and | and | and |
| | astringent | creamy, | creamy, | creamy, | creamy |
| | | some | some | little | |
| | | chalkiness | chalkiness | chalkiness | |
| Taste | High | Medium | Medium | Medium | Some |
| | cardboard, | cardboard, | beany | beany | green, |
| | beany | beany | off-flavor | off-flavor, | grass, |
| | off-flavor | off-flavor | | some | rapeseed |
| | | | | green | off-flavors |
| | | | | notes | |

TABLE 9
Compositions of cream cheese analogues containing rapeseed protein isolate and pea protein
isolate in ratio 1:3. Total level of protein powder was set at 6.0% and 10% w/w.

| Sample nr | 20 | 21 | 22 | 23 | 24 |
|---|---|---|---|---|---|
| Ingredient % w/w | RPI-PPI | RPI-PPI | RPI-PPI | RPI-PPI | RPI-PPI |
| | 1:3 | 1:3 | 1:3 | 1:3 | 1:3 |
| Total level of | 6.0% | 6.0% | 10% | 10% | 10% |
| protein powder w/w | | | | | |
| Coconut oil | 12 | 12 | 12 | 12 | 12 |
| Sunflower oil | 11 | 11 | 11 | 11 | 11 |
| Potato starch | 3.0 | 2.7 | 3.0 | 2.7 | 1.75 |
| (Avebe, Etenia 457) | | | | | |
| Potato starch | 2.6 | 2.3 | 2.6 | 2.3 | 1.5 |
| (Avebe, Etenia 505) | | | | | |
| CanolaPRO rapeseed | 1.5 | 1.5 | 2.5 | 2.5 | 2.5 |
| protein (DSM) | | | | | |
| Pea protein isolate | 4.5 | 4.5 | 7.5 | 7.5 | 7.5 |
| DMPP80Plus | | | | | |
| Sucrose | 1.5 | 1.5 | 1.5 | 1.5 | 1.5 |
| Calcium phosphate | 0.33 | 0.33 | 0.33 | 0.33 | 0.33 |
| NaCl | 0.8 | 0.8 | 0.8 | 0.8 | 0.8 |
| LM-pectin (DSM, | 0.5 | 0.5 | 0.5 | 0.5 | 0.5 |
| APC300FB) | | | | | |
| 0.2M Lactic acid/ | 1.9 | 0.7 | 3.1 | 2.0 | 1.9 |
| 0.1M citric acid | | | | | |
| Water | 63 | 63 | 63 | 63 | 63 |
| Total weight (g) | 103 | 101 | 108 | 106 | 104 |
| pH | 4.21 | 4.91 | 4.19 | 4.64 | 4.63 |
| L* | 96.00 | 91.55 | 93.78 | 89.70 | 88.95 |
| a* | −0.93 | −2.34 | −0.50 | −1.89 | −2.08 |
| b* | 9.51 | 6.97 | 11.02 | 8.65 | 8.91 |
| Median particle | 32 | 16 | 26 | 11 | 9 |
| size (μm) | | | | | |
| Texture analysis: | 71 | 62 | 80 | 77 | 45 |
| Firmness (N) | | | | | |
| Texture analysis: | 335 | 294 | 375 | 368 | 222 |
| spreadability | | | | | |
| (N · s) | | | | | |
| Appearance | Light | Light | Light | Light | Light |
| | beige/ | beige/ | beige/ | beige/ | beige/ |
| | yellowish, | greyish, | yellowish, | greyish, | greyish, |
| | shiny, | shiny, | shiny, | shiny, | shiny, |
| | without | without | without | without | without |
| | syneresis | syneresis | syneresis | syneresis | syneresis |
| Spreadability | Good | Good | Good | Good | Good |
| | spreadability, | spreadability | spreadability, | spreadability, | spreadability |
| | bit too | | bit too | bit too | |
| | firm | | firm | firm | |
| Mouthfeel | Smooth | Smooth | Bit | Bit | Smooth |
| | and | and | powdery | powdery | and |
| | creamy, | creamy, | and | and | creamy, |
| | some | limited | astringent | astringent | medium |
| | chalkiness | chalkiness | | | chalkiness |
| Taste | Good | Good | Intense | Intense | Intense |
| | taste, | taste, | beany | beany | beany |
| | medium | medium | off-flavor, | off-flavor, | off-flavor, |
| | beany | beany | too acidic | too acidic | too acidic |
| | off-flavor | off-flavor | | | |

Further, reference is made to the figures. FIG. 1 shows that sample nr 15 with 100% pea protein provides a spreadability that is weak, coarse and with a crumbly consistency. FIG. 2 shows that sample nr. 17, with 75% pea protein and 25% rapeseed protein provides a spreadability that is smooth, without irregularities such as lumps or grits.

To compare the spreadability and hardness that characterize proper spread-like properties, a conventional cream cheese, mayonnaise, butter, cottage cheese and Boursin were profiled by the same method. The results are listed in table 10 below.

TABLE 10
Textural properties of commercially available cream cheese, Boursin
soft cheese, cottage cheese, butter and mayonnaise at 4° C.

| | | Texture analysis: |
|---|---|---|
| | Texture analysis: | spreadability |
| Product | Firmness (N) | (N · s) |
| Cream cheese (Philadelphia, | 103 | 470 |
| original, Kraft Foods) | | |
| A: Mayonnaise (Original, Heinz) | 18 | 105 |
| B: Butter (Botergoud, Campina) | 678 | 2640 |
| C: Cottage cheese (Hutten kase, | 32 | 173 |
| original, Danone) | | |
| D: Boursin soft cheese (Garlic | 216 | 955 |
| and herb, Bel Group) | | |

Further, FIG. 3 shows photographs of actual spreading behaviour of the samples A, B, C and D of table 9.

1. A composition comprising rapeseed protein, a vegetable oil, starch and water, wherein the composition has a pH from 3-5.5.

2. The composition according to claim 1, which is a cream cheese analogue.

3. The composition according to claim 1, wherein the vegetable oil comprises a vegetable oil having a solid fat content of 40-90% (w/w), optionally 45-80% (w/w), or 50-70% (w/w) at 5° C.

4. The composition according to claim 1, wherein the vegetable oil is liquid at 5° C., or wherein the vegetable oil is solid at 5° C., or a combination thereof.

5. The composition according to claim 1, wherein the amount of rapeseed protein is from 0.1-10% (w/w), wherein the amount of vegetable oil is from 10-40% (w/w) and/or wherein the amount of starch is from 1-15% (w/w).

6. The composition according to claim 1, wherein the rapeseed protein comprises 40-65% (w/w) cruciferins and 35-60% (w/w) napins, or wherein the rapeseed protein comprises 60-80% (w/w) cruciferins and 20-40% (w/w) napins, or wherein the rapeseed protein comprises 0-20% (w/w) cruciferins and 80-100% (w/w) napins, wherein the sum of cruciferins and napins is not exceeding 100% (w/w).

7. The composition according to claim 1, further comprising an emulsifier and/or a hydrocolloid, optionally wherein the amount of emulsifier is from 0.02-2% (w/w), optionally wherein the amount of hydrocolloid is from 0.02-1% (w/w).

8. The composition according to claim 1, further comprising pea protein, wherein the ratio of pea protein:rapeseed protein is 90:10 to 5:95.

9. The composition according to claim 1, further comprising a plant-based material, optionally a plant-based material chosen from the group of soybean, pea, chickpea, fava bean, lentil, mung bean, peanut, lupin, rapeseed, camelina, sesame, sunflower, wheat, barley, oat, rice, sorghum, quinoa, buckwheat, almond, hazelnut, walnut, cashew and coconut.

10. The composition according to claim 1, wherein the composition is a cream cheese analogue which has a spreadable consistency at a temperature of 2-10° C.

11. The composition according to claim 1, having a spreadability measured according to test A within the range of 200 to 2000 N·s.

12. The composition according to claim 1, having a firmness measured according to test A within the range of 30 to 500 N.

13. The composition according to claim 1, wherein the rapeseed protein has a DIAAS value which is equal to or higher than 100.

14. The composition according to claim 1, wherein the composition is an oil-in-water emulsion, optionally wherein the size of the emulsion droplets has a D50 within the range of 1-50 μm.

15. A method for preparation of a fresh cheese analogue, comprising:
a) preparing an emulsion comprising rapeseed protein, a vegetable oil, starch and water;
b) homogenizing the emulsion, optionally using high shear; and
c) pasteurizing a composition thereof.

16. The method according to claim 15, wherein the emulsion obtained in a) has a pH from 2-6.5, optionally a pH from 3-5.5, optionally a pH from 3-5.5.

17. The method according to claim 15, wherein the emulsion obtained in a) has a droplet size D50 of less than 50 μm.

18. The method according to claim 15, wherein a) comprises using a hydrocolloid and/or an emulsifier.

19. The composition as defined in claim 1 in a cheese analogue, optionally a fresh cheese analogue chosen from the group of cream cheese, feta, mozzarella, crème fraiche, fromage blanc, ricotta, mascarpone, cheese spread and quarg.
